(19) United States
(12) Patent Application Publication
(10) Pub. No.: US 2009/0285403 A1
(43) Pub. Date: Nov. 19, 2009

(54) Method and Apparatus for Improving Audio Reproduction for a Portable Electronic Device

(76) Inventors: Neng-Wen Yeh, Taipei Hsien (TW); Yung-Sen Lin, Taipei Hsien (TW); Kuan-Chi Juan, Taipei Hsien (TW); Po-Yu Li, Taipei Hsien (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/272,864

(22) Filed: Nov. 18, 2008

(30) Foreign Application Priority Data
May 13, 2008 (TW) 097117563

(51) Int. Cl. H04R 5/00

(52) U.S. Cl. 381/1

(57) ABSTRACT

The present invention discloses an audio signal processing device capable of transmitting at least one audio signal generated by an audio decoder to at least one first speaker and a second speaker. The audio signal processing device includes a signal mixer and at least one filter. By the at least one filter, a first signal having a frequency larger than a first specific frequency in each audio signal is transmitted to at least one first speaker, and a second signal having a frequency smaller than the first specific frequency in each audio signal is transmitted to the signal mixer and then transmitted to the second speaker.

### FIELD

The exemplary embodiment(s) of the present invention relates to signal processing for a portable electronic device, and more specifically, the embodiment(s) of the present invention relates to audio signal processing.

### BACKGROUND

As functionalities and qualities of portable electronic devices (such as Notebook computers or handheld devices) continue to advance, users demand higher standards for multimedia performances of typical portable devices. Sound systems have evolved from early days of mono and/or stereo sound quality to multi-channel designs seen in modern computers. Due to space limitations, notebook computers, however, are often equipped with relative small speakers with low power output. For example, notebook computers with multi-channel sound systems are typically equipped with small speakers, which often fail to deliver quality sound reproduction.

Frequency response of a conventional speaker, for instance, should be within the frequency range of 20 Hertz (“Hz”) to 20,000 Hz. In order to emphasize special sound effects (such as bass tones), a subwoofer is often capable of generating audio signals below 120 Hz. For typical notebook computers, even those equipped with multi-channel speakers cannot generally meet the requirement for high quality sound. As such, notebook computers using typical stereo designs cannot provide satisfactory sound reproduction.

### SUMMARY

It is an object of the present invention to provide an audio signal processing device for concentrating some of the audio frequencies of an audio signal on a speaker having better performance in sound reproduction.

It is another object of the present invention to provide a portable electronic device comprising an audio signal processing device for concentrating some of the audio frequencies of an audio signal on a speaker having better performance in sound reproduction.

It is still another object of the present invention to provide a method for processing audio signals for concentrating some of the audio frequencies of an audio signal on a speaker having better performance in sound reproduction.

In order to achieve the above objects, the present invention provides a portable electronic device comprising an audio decoder, at least one first speaker, a second speaker, and an audio signal processing device, wherein the audio signal processing device electrically couples with the audio decoder, the at least one first speaker, and the second speaker.

The audio signal processing device comprises a signal mixer and at least one filter. The at least one filter transmits a first signal larger than a first specific frequency in each audio signal to at least one first speaker, transmits a second signal smaller than the first specific frequency to the signal mixer for processing, and then transmits the processed signal to the second speaker.

### BRIEF DESCRIPTION OF THE DRAWINGS

The exemplary embodiment(s) of the present invention will be understood more fully from the detailed description given below and from the accompanying drawings of various embodiments of the invention, which, however, should not be taken to limit the invention to the specific embodiment(s), but are for explanation and understanding only.

FIG. 1 illustrates a structural view of a portable electronic device in accordance of one embodiment of the present invention;

FIG. 2 illustrates a structural view of a first embodiment of an audio signal processing device in accordance of one embodiment of the present invention;

FIG. 2A illustrates a structural view of the audio signal processing device coupled with an external speaker in accordance of one embodiment of present invention;

FIG. 3 illustrates a structural view of a second embodiment of an audio signal processing device in accordance of one embodiment of the present invention; and

FIG. 4 is a flowchart illustrating a method for processing audio signals in accordance of one embodiment of the present invention.

### DETAILED DESCRIPTION

Exemplary embodiments of the present invention are described herein in the context of a method, system and apparatus for improving audio-sound reproduction.

Those of ordinary skills in the art will realize that the following detailed description of the exemplary embodiment(s) is illustrative only and is not intended to be in any way limiting. Other embodiments will readily suggest themselves to such skilled persons having the benefit of this disclosure. Reference will now be made in detail to implementations of the exemplary embodiment(s) as illustrated in the accompanying drawings. The same reference indicators will be used throughout the drawings and the following detailed description to refer to the same or like parts.

In accordance with the embodiment(s) of the present invention, the components, process steps, and/or data structures described herein may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. Where a method comprising a series of process steps is implemented by a computer or a machine and those process steps can be stored as a series of instructions readable by the machine, they may be stored on a tangible medium such as a computer memory device (e.g., ROM (Read Only Memory), PROM (Programmable Read Only Memory), EEPROM (Electrically Erasable Programmable Read Only Memory), FLASH Memory, Jump Drive, and the like), magnetic storage medium (e.g., tape, magnetic disk drive, and the like), optical storage medium (e.g., CD-ROM, DVD-ROM, paper card and paper tape, and the like) and other known types of program memory.

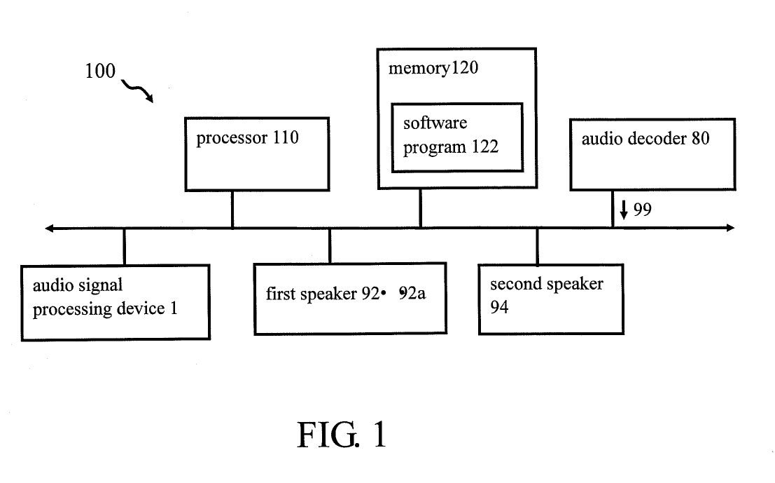

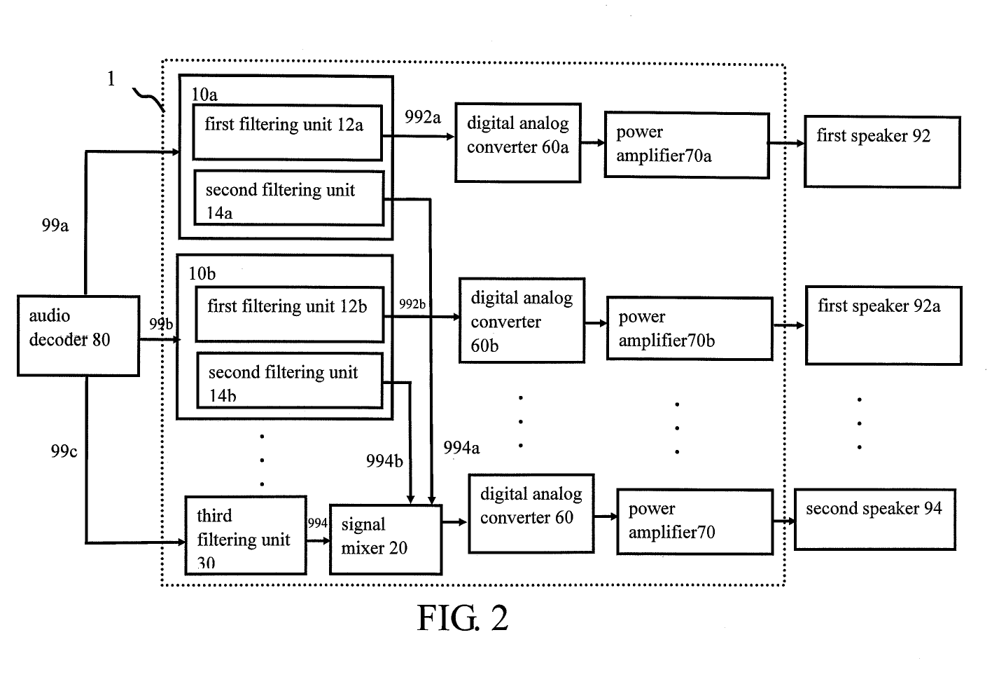

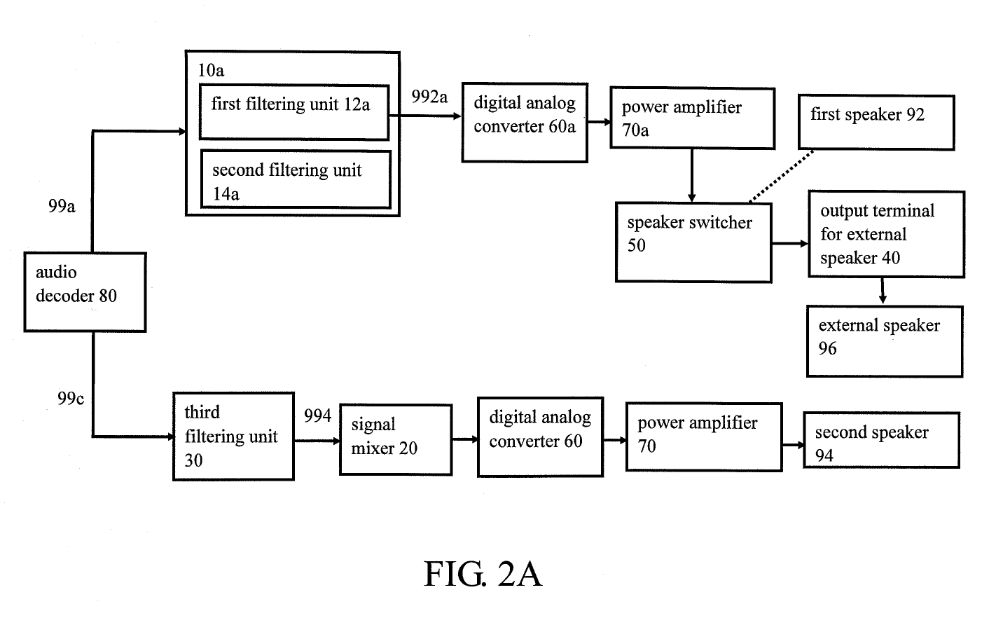

FIG. 1 illustrates a structural view of a portable electronic device in accordance with one embodiment of the present invention. A portable electronic device 100 includes a processor 110, a memory 120, an audio decoder 80, an audio signal processing device 1, a set of first speakers 92 and 92a, and a second speaker 94. In one embodiment, the portable electronic device 100 is a notebook computer. It is noted that the portable electronic device 100 is capable of operating between one (1) and more first speakers. To simplify the technical discussion, only two first speakers 92 and 92a are illustrated or shown in FIG. 1 and FIG. 2.

The audio decoder 80 is capable of decoding/encoding audio signals wherein the audio decoder 80 encodes analog audio information into digital audio information and decodes the digital audio information to restore the analog audio information. The audio decoder 80 decodes the digital audio signal and subsequently generates at least one audio signal 99 in response to the digital audio signal. When the portable electronic device 100 requires supporting multiple speakers, the audio decoder 80 is configured to provide multiple independent audio signals 99 corresponding to the number of speakers, wherein each audio signal 99, for example, is dedicated to one speaker. To simplify the discussion hereinafter, the audio signals 99a, 99b, and 99c, shown in FIG. 2, are illustrated.

In this embodiment, the portable electronic device 100 has six audio channels supporting five (5) first speakers 92 and 92a and one (1) second speaker 94. It should be noted that the number of first speakers and second speakers are not limited. The second speaker 94, in one embodiment, provides better performance whereby the audio signal processing device 1 filters the audio frequencies which the first speakers 92 or 92a cannot properly reproduce and concentrates and/or reroutes those audio frequencies to the second speaker 94 for reproduction.

The memory 120 includes a software program 122. The processor 110 executes the software program 122 stored in the memory 120 to carry out the objectives of one embodiment of the present invention.

FIG. 2 illustrates a structural view of a first embodiment of an audio signal processing device in accordance with embodiment of the present invention. The audio signal processing device 1 electrically couples with the audio decoder 80, at least one first speaker, and the second speaker. The audio signals 99a, 99b, 99c generated by the audio decoder 80 are processed and transmitted by the audio signal processing device 1 to the first speaker 92, 92a and the second speaker 94.

In one embodiment, the audio signal processing device 1 includes filters 10a, 10b, a third filtering unit 30, a signal mixer 20, digital analog converters 60, 60a, 60b, and power amplifiers 70, 70a, 70b. Each one of the filters 10a and 10b includes first filtering units 12a-12b and second filtering units 14a-14b. It is noted that the first filtering unit 12a and the second filtering unit 14a of the filter 10a, and the first filtering unit 12b and the second filtering unit 14b of the filter 10b, can be either implemented independently or integrated as a whole.

The first filtering unit 12a, the digital analog converter 60a, and the power amplifier 70a are electrically coupled with each other. The first filtering unit 12b, the digital analog converter 60b, and the power amplifier 70b are electrically coupled with each other. The second filtering unit 14a, the signal mixer 20, the digital analog converter 60, and the power amplifier 70 are electrically coupled with each other. The second filtering unit 14b, the signal mixer 20, the digital analog converter 60, and the power amplifier 70 are electrically coupled with each other.

To identify audio signal(s) that can be reproduced by the first speakers, the first filtering units 12a, 12b are used to filter first signals having a frequency larger than a first (predefined) specific frequency (that is, audio signals can be reproduced by the first speakers 92, 92a) from each audio signal 99a, 99b to obtain first filtered signals 992a, 992b. The first filtered signals 992a and 992b are subsequently processed by the digital analog converters 60a and 60b, respectively and forwarded to power amplifier 70a and 70b. After amplification of the audio signals, the first filtered signals 992a and 992b are transmitted by the power amplifier 70a and 70b to the first speakers 92 and 92a. Therefore, the audio frequency of the first filtered signals 992a, 992b has a range corresponding to the frequency in which the first speaker 92, 92a can handle. It is noted that the “first specific frequency” can be specified to cause the audio signals 99a, 99b to correspond to different first specific frequencies.

The second filtering units 14a, 14b filter a second signal having a frequency or frequencies smaller than the first specific frequency (that is, audio signals that cannot be reproduced by the first speakers 92, 92a) from the audio signals 99a, 99b. After obtaining the second filtered signals 994a, 994b, they are subsequently transmitted to the signal mixer 20. The signal mixer 20 processes the second filtered signals 994a-994b and transmits the second filtered signals 994a-994b to the digital analog converter 60. After amplification, the power amplifier 70 forwards the second filtered signals 994a, 994b to the second speaker 94.

The digital analog converter 60 performs digital to analog conversion and matches with the power amplifier 70. For example, the digital analog converter 60 is capable of selecting signals based on the audio signal source. It is noted that the power amplifier 70 can perform digital to analog conversion and it is not required to cooperate with the digital analog converter 60.

The power amplifier 70 can be a digital power amplifier or an analog power amplifier. For example, the power amplifier 70 can be a class-D amplifier.

It is possible that the second speaker 94 has its own limitation and cannot provide proper low frequency sound reproduction. As such, it is necessary to filter out the audio frequencies of the audio signal 99c that cannot be reproduced by the second speaker 94. The embodiment(s) of the present invention discloses a third filtering unit 30 electrically coupled with the audio decoder 80 and the signal mixer 20.The third filtering unit 30 filters out a third signal having a frequency or frequencies smaller than a second specific frequency (such as frequencies below 20 Hz) to avoid sound(audio) distortion and/or extra power consumption. In one embodiment, the second specific frequency is smaller than the first specific frequency. The second filtered signal 994 is processed by the third filtering unit 30 and is subsequently transmitted to the signal mixer 20.

It is noted that the third filtering unit 30 is adopted based on actual requirements. The third filtering unit 30, for example, may be omitted if no significant effect is achieved.

If, for example, the first speaker 92 does not perform well at frequencies below under 120 Hz, the audio decoder 80 decodes the audio signal 99a and transmits it to the filter 10a, and then the first filtering unit 12a retains the first signal larger than 120 Hz to be the first filtered signal 992a. The first filtered signal 992a is then processed by the digital analog converter 60a and the power amplifier 70a subsequently transmits the first filtered signal 992a to the first speaker 92. Meanwhile, the second filtering unit 14a filters the second signal under 120 Hz to be the second filtered signal 994a. The second filtered signal 994a is processed by the signal mixer 20, the digital analog converter 60 and the power amplifier 70, and then transmitted to the second speaker 94.

It is noted that the signal mixer 20, the filter 10a, 10b and the digital analog converter 60, 60a, 60b can be implemented independently, or the signal mixer 20 and/or the filter 10a, 10b and/or the digital analog converter 60, 60a, 60b and/or the audio decoder 80 can be integrated as a whole.

By using the software program 122 to adjust the parameters of the first specific frequency and the second specific frequency, it is possible to use speakers having different specifications and to meet different performance requirements.

The signal mixer 20 can be a digital signal mixer or an analog signal mixer or a combination of digital and analog signal mixer to mix the audio signals using digital or analog mechanisms. The digital signal mixer can combine the second filtered signals 994a and 994b or multiply the second filtered signals 994a and 994b by a specific ratio and then combine the second filtered signals 994a and 994b. It should be noted that the analog signal mixer has to apply additional circuit design to amplify the audio signals.

In one embodiment, the signal mixer 20 is a digital signal processor for facilitating the filtering, providing frequency division, and mixing effects without requiring sophisticated electronic circuitry. For example, the signal mixer 20 can increase the gain value of the second filtered signal 994a and the second filtered signal 994b to emphasize the low frequency effects of the two front channels. In addition, it can apply delay to some channels to generate echo effects.

It is noted that the digital signal processor can be integrated with the audio decoder 80.

FIG. 2A illustrates a structural view of the audio signal processing device coupled with an external speaker in accordance with one embodiment of the present invention. In order to provide flexibility, the audio signal processing device 1 further includes at least one output terminal for external speaker 40 and at least one speaker switcher 50. The power amplifier 70a, each output terminal for external speaker 40, and each speaker switcher 50 are electrically coupled with each other. The speaker switcher 50 allows a user to choose between the built-in speakers of the portable electronic device 100 and an external speaker 96. In FIG. 2A, the external speaker 96 is used to replace the first speaker 92. When the output terminal for external speaker 40 electrically couples with the external speaker 96, the speaker switcher 50 automatically redirects the audio signal to the external speaker 96.

The external speaker 96 usually performs better than the built-in speaker. When the audio signal processing device 1 detects the external speaker 96 coupled with the output terminal for external speaker 40, the audio signal 99a transmitted by the audio decoder 80 via filter 10a is transmitted completely without filtering process through the first filtering unit 12a. Upon detecting the external speaker 96, the audio signal 99a, for example, bypasses the second filtering unit 14a whereby no signal is transmitted to the signal mixer 20 from the filter 10a.

It is noted that the number of the speaker switcher 50 and the output terminal for external speaker 40 is not limited, nor are the locations and operations thereof.

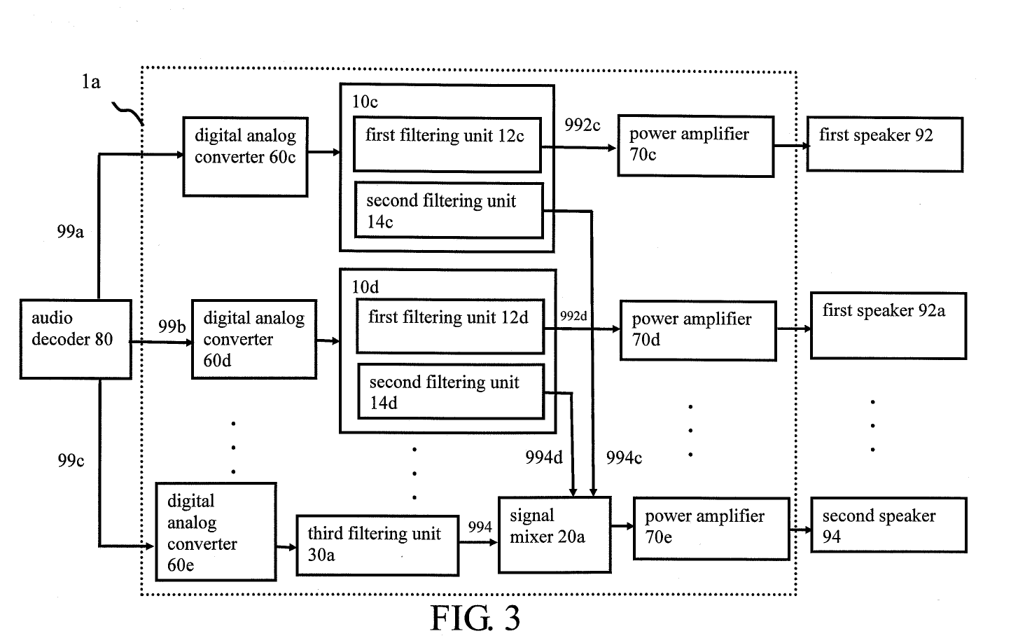

Please refer to FIG. 3, which illustrates a structural view of a second embodiment of an audio signal processing device in the present invention. In this embodiment, the audio signal processing device 1 a includes filters 10c, 10d, a third filtering unit 30a, a signal mixer 20a, digital analog converters 60c, 60d, 60e, and power amplifiers 70, 70a, 70b. The filter 10c includes a first filtering unit 12c and a second filtering unit 14c, and the filter 10d includes a first filtering unit 12d and a second filtering unit 14d.

The filters 10c, 10d of the audio signal processing device 1a operate in substantially the same manner as the filters 10a, 10b in the first embodiment. The third filtering unit 30a operates in substantially the same manner as the third filtering unit 30 in the first embodiment. The signal mixer 20a operates in substantially the same manner as the signal mixer 20 in the first embodiment. The major difference between the first and the second embodiments is that the filters 10c, 10d and the third filtering unit 30a are analog filters. As such the signal mixer 20a is for example an analog signal mixer.

It is noted that if digital filters are to be applied in the second embodiment, then an analog-to-digital filter and a digital to analog filter have to be disposed at the front end and the back end of the filters 10c, 10d respectively.

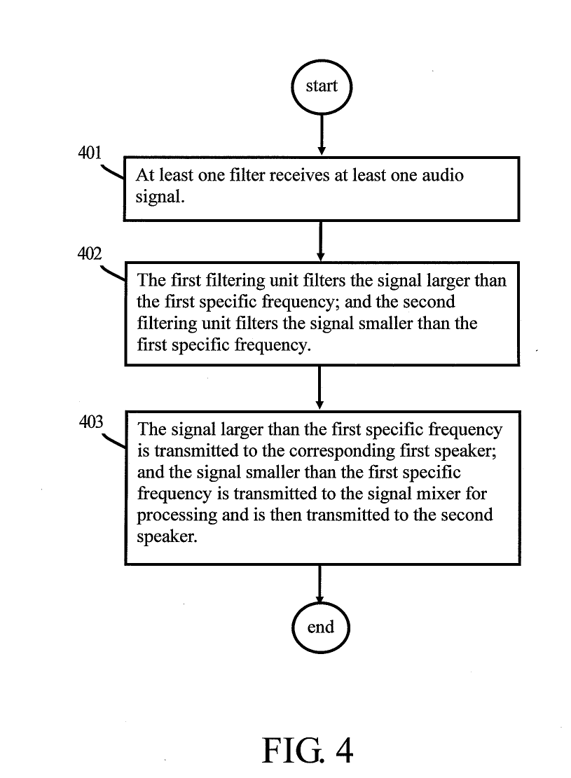

FIG. 4 is a flowchart illustrating a method for processing audio signals in accordance with one embodiment of the present invention. The process illustrated in the flowchart follows operations implemented by the portable electronic device illustrated in FIG. 2. Step 401: At least one filter receives at least one audio signal.

The audio decoder generates at least one audio signal and transmits it to at least one filter. Each includes a first filtering unit and a second filtering unit, wherein the first filtering unit and the second filtering unit operate the same as described above, so this will not be further described.

Step 402: The first filtering unit filters a first signal larger than the first specific frequency, and the second filtering unit filters a second signal smaller than the first specific frequency.

The audio signal transmitted to the filter is divided by the first filtering unit and the second filtering unit, wherein the first signal having a frequency larger than the first specific frequency is filtered by the first filtering unit, and the second signal having a frequency smaller than the first specific frequency is filtered by the second filtering unit.

Step 403: The first signal having a frequency larger than the first specific frequency is transmitted to the corresponding first speaker, and the second signal having a frequency smaller than the first specific frequency is transmitted to the signal mixer for processing and is then transmitted to the second speaker.

In this step, the signal larger than the first specific frequency is outputted by the corresponding first speaker, and the signal smaller than the first specific frequency is transmitted to the signal mixer for processing and is then transmitted to the second speaker for sound reproduction. Before transmitting the signals to the first speaker and the second speaker respectively, operations such as digital/analog conversion and power amplification can be executed if necessary.

It is noted that the above-mentioned embodiments are only for illustration. It is intended that the present invention cover modifications and variations of this invention provided they fall within the scope of the following claims and their equivalents. Therefore, it will be apparent to those skilled in the art that various modifications and variations can be made to the structure of the present invention without departing from the scope or spirit of the invention.

What is claimed is:

1. An audio signal processing device for transmitting at least one audio signal generated by an audio decoder to at least one first speaker and a second speaker, the audio signal processing device comprising:
a signal mixer; and
at least one filter coupled with the signal mixer, the at least one filter corresponding to the at least one audio signal, the at least one filter transmitting a first signal having a frequency larger than a first specific frequency in the corresponding audio signal to at least one first speaker and transmitting a second signal having a frequency smaller than the first specific frequency in the corresponding audio signal to the signal mixer for processing and then transmitting to the second speaker.

2. The audio signal processing device of claim 1, wherein each filter comprises a first filtering unit and a second filtering unit, the first filtering unit transmitting the first signal having a frequency larger than the first specific frequency in the corresponding audio signal to at least one first speaker, the second filtering unit transmitting the second signal having a frequency smaller than the first specific frequency in the corresponding audio signal to the signal mixer for processing and then transmitting to the second speaker.

3. The audio signal processing device of claim 1, wherein the signal mixer is a digital signal mixer or an analog signal mixer.

4. The audio signal processing device of claim 3, wherein the signal mixer is a digital signal processor.

5. The audio signal processing device of claim 3, wherein the audio signal processing device further comprises at least one power amplifier, the at least one power amplifier electrically coupling with the at least one filter respectively, each power amplifier being a digital power amplifier or an analog power amplifier.

6. The audio signal processing device of claim 5, wherein each power amplifier is a class-D amplifier.

7. The audio signal processing device of claim 5, wherein the audio signal processing device further comprises at least one digital analog converter, the least one digital analog converter electrically coupling with the at least one filter respectively.

8. The audio signal processing device of claim 2, wherein the audio signal processing device further comprises a third filtering unit, the third filtering unit electrically coupling with the audio decoder and the signal mixer respectively; the third filtering unit is provided for filtering a third signal smaller than a second specific frequency in the audio signal.

9. The audio signal processing device of claim 8, wherein the second specific frequency is smaller than the first specific frequency.

10. The audio signal processing device of claim 1, wherein the audio signal processing device further comprises at least one output terminal and at least one speaker switcher, the at least one first speaker electrically coupling with the at least one output terminal and the at least one speaker switcher respectively.

11. A portable electronic device, comprising:
an audio decoder for generating at least one audio signal;
at least one first speaker;
a second speaker;
an audio signal processing device electrically coupling with the audio decoder, the at least one first speaker, and the second speaker, the audio signal processing device comprising:
a signal mixer electrically coupled to the audio decoder; and
at least one filter electrically coupled with the audio decoder and the signal mixer respectively, the at least one filter corresponding to the at least one audio signal respectively, the at least one filter transmitting a first signal larger than a first specific frequency in the corresponding audio signal to at least one first speaker and transmitting a second signal smaller than the first specific frequency to the signal mixer for processing and then transmitting to the second speaker.

12. The portable electronic device of claim 11, wherein each filter comprises a first filtering unit and a second filtering unit, the first filtering unit transmitting the first signal larger than the first specific frequency in the corresponding audio signal to at least one first speaker, the second filtering unit transmitting the second signal smaller than the first specific frequency in the corresponding audio signal to the signal mixer for processing and then transmitting to the second speaker.

13. The portable electronic device of claim 11, wherein the signal mixer is a digital signal mixer or an analog signal mixer.

14. The portable electronic device of claim 13, wherein the signal mixer is a digital signal processor.

15. The portable electronic device of claim 13, wherein the audio signal processing device further comprises at least one power amplifier, the at least one power amplifier electrically coupling with the at least one filter respectively, each power amplifier being a digital power amplifier or an analog power amplifier.

16. The portable electronic device of claim 15, wherein each power amplifier is a class-D amplifier.

17. The portable electronic device of claim 15, wherein the audio signal processing device further comprises at least one digital analog converter, the least one digital analog converter electrically coupling with the at least one filter respectively.

18. The portable electronic device of claim 12, wherein the audio signal processing device further comprises a third filtering unit, the third filtering unit electrically coupling with the audio decoder and the signal mixer respectively; the third filtering unit is provided for filtering a third signal smaller than a second specific frequency in the audio signal.

19. The portable electronic device of claim 18, wherein the second specific frequency is smaller than the first specific frequency.

20. The portable electronic device of claim 11, wherein the audio signal processing device further comprises at least one output terminal and at least one speaker switcher, the at least one first speaker electrically coupling with the at least one output terminal and the at least one speaker switcher respectively.

21. An audio signal processing method for use with a portable electronic device, the portable electronic device comprising a processor, a memory having a software program, an audio signal processing device, at least one first speaker and a second speaker, wherein the audio signal processing device comprises a signal mixer and at least one filter, the processor executing the software program of the memory to carry out the following steps:
(A) the at least one filter receiving at least one audio signal respectively;
(B) the at least one filter filtering a first signal larger than a first specific frequency and filtering a second signal smaller than the first specific frequency; and
(C) transmitting the first signal larger than a first specific frequency in the audio signal to the at least one first speaker and transmitting the second signal smaller than the first specific frequency to the signal mixer for processing and then transmitting to the second speaker.

22. The audio signal processing method of claim 21, wherein each filter comprises a first filtering unit and a second filtering unit, while in step (B), the first filtering unit filters the first signal larger than the first specific frequency, and the second filtering unit filters the second signal smaller than the first specific frequency.

23. The audio signal processing method of claim 21, wherein the signal mixer is a digital signal processor.

24. An audio signal processing device, comprising:
a signal decoder capable of receiving a plurality of audio signals;
a filter, coupled to the signal decoder, capable of distributing the plurality of audio signals to one or more first speakers and a second speaker in response to a predefined specific frequency.

25. The audio signal processing device of claim 24, wherein the filter includes a first filtering unit and a second filtering unit, wherein the first filtering unit is configured to direct a first filtered signal to a first speaker and wherein the second filtering unit is configured to direct a second filtered signal to a second speaker.

26. The audio signal processing device of claim 25, wherein the first filtering unit forwards the first filtered signal to the first speaker when the first filtered signal having a frequency greater than the predefined specific frequency.

27. The audio signal processing device of claim 26, wherein the second filtering unit forwards the second filtered signal to the second speaker when the second filtered signal having a frequency smaller than the predefined specific frequency.

28. The audio signal processing device of claim 27, further comprising a third filtering unit coupled to the signal decoder and capable of removing audio signals having frequency greater than a predefined maximum allowed frequency.

29. The audio signal processing device of claim 28, further comprising a signal mixer 20 coupled with signal decoder and capable of facilitating audio output via the second speaker.

30. The audio signal processing device of claim 29, wherein the filter forwards the plurality of audio signals without performing of filtering process when external speakers are detected.
